(19) United States
(12) Patent Application Publication
(10) Pub. No.: US 2016/0192310 A1
(43) Pub. Date: Jun. 30, 2016

(54) Method and a Device for Sending a Synchronization Signal

(71) Applicant: Telefonaktiebolaget L M Ericsson (publ), Stockholm (SE)

(72) Inventor: Stefano SORRENTINO, Solna (SE)

(21) Appl. No.: 14/911,284

(22) PCT Filed: Aug. 11, 2013
(86) PCT No.: PCT/SE2013/000123

§ 371 Date: Feb. 10, 2016

(51) Int. Cl. H04W 56/00; H04W 4/00; H04J 3/06

(52) U.S. Cl. CPC H04W 56/0025; H04J 3/0638; H04W 4/005

(57) ABSTRACT

The exemplary embodiments relate to a method (800) and a first Device-to-Device, D2D, communication enabled device (1000) for operating as a synchronization reference to other D2D communication enabled devices located within radio coverage of the first D2D communication enabled device. According to the method (800), the first D2D communication enabled device transmits (820) a synchronization signal that conveys information about an intention of the first D2D communication enabled device regarding operation as a synchronization reference to the other D2D communication enabled devices.

### TECHNICAL FIELD

The present embodiments relate to synchronization in a communication system. In particular, it relates to a method and a device for sending a synchronization signal in a communication system.

### BACKGROUND

Within the field of telecommunications, so called device-to-device (D2D) communication has been promoted as a means to provide peer-to-peer services between User Equipments (UEs). Device-to-device communication is a well-known and widely used component of many existing wireless technologies, including ad hoc and cellular networks. Examples include Bluetooth and several variants of the IEEE 802.11 standards suite such as WiFi Direct. These systems operate in unlicensed spectrum.

Recently, device-to-device (D2D) communications as an underlay to cellular networks have been proposed as a means to take advantage of the proximity of communicating devices and at the same time to allow devices to operate in a controlled interference environment. Typically, it is suggested that such device-to-device communication shares the same spectrum as the cellular system, for example by reserving some of the cellular uplink resources for device-to-device purposes. Allocating dedicated spectrum for device-to-device purposes is a less likely alternative as spectrum is a scarce resource and (dynamic) sharing between the device-to-device services and cellular services is more flexible and provides higher spectrum efficiency.

D2D communication enables infrastructure-less communication between wireless devices. This may be of importance in, for example, emergency, national security and public safety situations, since during these situations load on the radio communication network(s) is generally high. Furthermore, an emergency situation may for example occur where only limited coverage by the radio communication system is provided, or where the infrastructure network is damaged. In such a situation, D2D communication may improve coverage by allowing a wireless device, e g a User Equipment (UE) to connect to the radio communication network via another wireless device or UE. In addition, local communication between wireless devices using D2D communication is achievable without a need for radio coverage by the radio communication network or in general, without a need for radio coverage of a cellular infrastructure independently whether the infrastructure comprises one radio access technology (RAT) or a plurality of RATs. An advantage with using D2D communication is that the capacity of a radio communication network is enhanced since traffic between wireless devices or UEs need not necessarily pass through the radio communication network nodes. As a result, the radio communication network may be offloaded in terms of traffic between wireless devices or UEs.

Some level of synchronisation is required between a transmitter and a receiver in D2D communication, e.g. between wireless devices or UEs. Network assisted device-to-device communication is well known in the art, wherein methods have been developed, wherein the network assists in the pairing and synchronisation of candidates for device-to-device communication. However, in order to fully achieve the advantages of off-loading the infrastructure of a cellular radio network, direct discovery enabling autonomous establishment of device-to-device communication is desired. The level of synchronisation required varies with the type of service intended to be pursued in the D2D communication.

Devices that want to communicate, or even just discover each other, typically need to transmit various forms of control signaling. One example of such control signaling is the so-called (discovery) beacon signal, which at least carries some form of identity and is transmitted by a device that wants to be discoverable by other devices. Other devices can scan for the beacon signal. For certain communication modes, for example connectionless communication typically employed for groupcast and broadcast transmission, the beacon signal might carry a scheduling assignment indicating the associated data transmission to potential receivers. Connectionless communication is typically a unidirectional communication mode that does not require acknowledged connection setup.

The 3rd Generation Partnership Project has produced a set of requirements for Proximity Service (ProSe) in Technical Report 3GPP TR 22.803. The goal is to provide local discovery and connectivity to UEs in proximity of each other. The ProSe Study Item recommends also supporting D2D operation for out of network (NW) coverage UEs. However, it is observed that the concept of out of coverage is somewhat unspecified in the ProSe requirements 3GPP TR 22.803. One aspect of out of coverage considered in this disclosure is the situation when the UE is unable to successfully communicate with any cellular NW which may act as support to ProSe operations, but other definitions of out of coverage are possible and the teachings of this disclosure are also applicable to such other definitions.

In such case, different synchronization options are possible: UEs may synchronize to a global reference (e.g., a GPS) which is in general different from the synchronization reference of deployed networks. Possibly UEs may operate in a fully asynchronous fashion, where no synchronization reference is used, at least for discovery. A further option is that clusters of UEs synchronize to a specific UE, in the following denoted Cluster Head (CH), which provides local synchronization to its neighbour UEs. In other words, the UE operating as the CH is a synchronization reference to the neighbour UEs in the cluster. The cluster of UEs comprises the specific UE operating as the CH as well as its neighbouring UEs for which the CH is a synchronization reference. Different clusters are not necessarily synchronized to each other.

If out of NW coverage synchronization is based on synchronization (sync) signals transmitted by CHs, unnecessarily frequent CH switches should be avoided, as the synchronization procedure involves signalling that is energy consuming for the UEs, and as service discontinuity may be experienced during transition from one CH to another CH. Frequent CH transition may also degrade the performance of the network, which benefits from a static interference pattern.

Thus, there is need for an improved synchronization mechanism that reduces the switching or transition of UEs between different synchronization references or CHs when out of NW coverage synchronization is based on sync signals transmitted by CHs.

### SUMMARY

An object according to the present embodiments is to alleviate at least some of the problems mentioned above. A further object according to some embodiments is to provide an improved mechanism for enabling synchronisation in device-to-device communication.

These and further objects are achieved, according to an aspect of exemplary embodiments, by a method, performed by a first Device-to-Device, D2D, communication enabled device for operating as a synchronization reference to other D2D communication enabled devices located within radio coverage of the first D2D communication enabled device. The first D2D communication enabled device transmits a synchronization signal that conveys information about an intention of the first D2D communication enabled device regarding operation as a synchronization reference to the other D2D communication enabled devices.

According to another aspect of exemplary embodiments, the above objects and further objects are achieved by a first Device-to-Device (D2D) communication enabled device for operating as a synchronization reference to other D2D communication enabled devices located within radio coverage of the first D2D communication enabled device. The first D2D communication enabled device comprises a transmitter that is configured to transmit a synchronization signal that conveys information about an intention of the first D2D communication enabled device regarding operation as a synchronization reference to the other D2D communication enabled devices. The first D2D communication enabled device further comprises a processor operatively connected to the transmitter and configured instruct the transmitter to transmit the synchronization signal.

The transmission of a synchronization signal that conveys information about an intention of the first D2D communication enabled device regarding operation as a synchronization reference allows D2D communication enabled devices or UEs to differentiate between Cluster Heads (CHs) or synchronization references that appear as a long-term reliable synchronization references and other CHs that have a temporary synchronization reference function. This has the effect that unnecessarily frequent CH switches can be avoided.

### BRIEF DESCRIPTION OF THE DRAWINGS

FIG. 1 is a diagram illustrating a scenario in a communication system.

FIG. 2 is a diagram illustrating a scenario in a communication system.

FIG. 3 is a diagram illustrating a scenario in a communication system.

FIG. 4 is a diagram illustrating a scenario in a communication system.

FIG. 5 is a diagram illustrating a scenario in a communication system.

FIG. 6 is a flowchart illustrating a method performed by a device according to the present embodiments.

FIG. 7 is a flowchart illustrating a method performed by a device according to the present embodiments.

FIG. 8 is a flowchart illustrating main method steps performed by a device according to the present embodiments.

FIG. 9 is a flowchart illustrating main method steps performed by a device according to the present embodiments.

FIG. 10 is a block diagram illustrating an exemplary device according to the present embodiments.

### DETAILED DESCRIPTION

Briefly described, the synchronization mechanism disclosed herein enable Device-to-Device (D2D) communication enabled devices such as User Equipments (UEs) of a cellular communication network that are also D2D communication enabled to distinguish between different D2D communication enabled devices operating as synchronization references so that they can select to synchronize to a suitable synchronization reference, depending on what are their needs for synchronization. To enable UEs or D2D communication enabled devices to identify a suitable synchronization reference, embodiments of this disclosure provide for synchronization signals that carry information about the “sync state” of the device transmitting them. By doing so, a receiver UE or D2D communication enabled device is able to detect whether a synchronization signal is a stable synchronization reference or a temporary signal transmitted by a broadcasting UE or D2D communication enabled device for the length of its communication session only. Different UE behaviours' are defined, where, e.g., UEs avoid synchronizing to sync signals transmitted by UEs transmitting connectionless communication unless they are interested in such communication.

The cellular network discussed herein may for example be a Long Term Evolution (LTE) network. It should however be mentioned that the exemplary embodiments described are not restricted to any particular radio access technology. In other words, the embodiments herein are applicable in systems such as GSM, WCDMA, LTE, CDMA200, WIMAX, GPS, etc. Furthermore, the terms UE and D2D communication enabled devices will be used interchangeably for brevity and should not be interpreted as limited to devices having one functionality but not the other. In the following discussion, D2D communication enabled devices will also be denoted D2D devices in order to avoid lengthy repetitions of terms.

If out of network (NW) coverage synchronization is based on synchronization (sync) signals transmitted by CHs, UEs or D2D communication enabled devices will need to be able to synchronize to a synchronization reference suitable for their needs. A number of procedures may be considered, with some similarities to cell search in cellular NWs where idle UEs search for sync signals from different cells and synchronize to, e.g., the cell with best signal strength. Similarly, ProSe enabled out of NW coverage UEs might synchronize to the strongest CH in proximity.

However, UEs transmitting data for connectionless communication assume typically the CH role and transmit synchronization signals, in order to allow the receivers, i e the receiving UEs or D2D communication enabled devices to locally synchronize to them and receive the data. In general, such UEs may cease to be CHs after the communication session is completed, which might be relatively short. Neighbour UEs might in the meantime abandon their synchronization reference in order to synchronize to the UE transmitting data even if not interested in the actual data transmission.

In the following, a detailed description of the exemplary embodiments of the present invention is described in conjunction with the drawings, in several scenarios to enable easier understanding the solution(s) described herein.

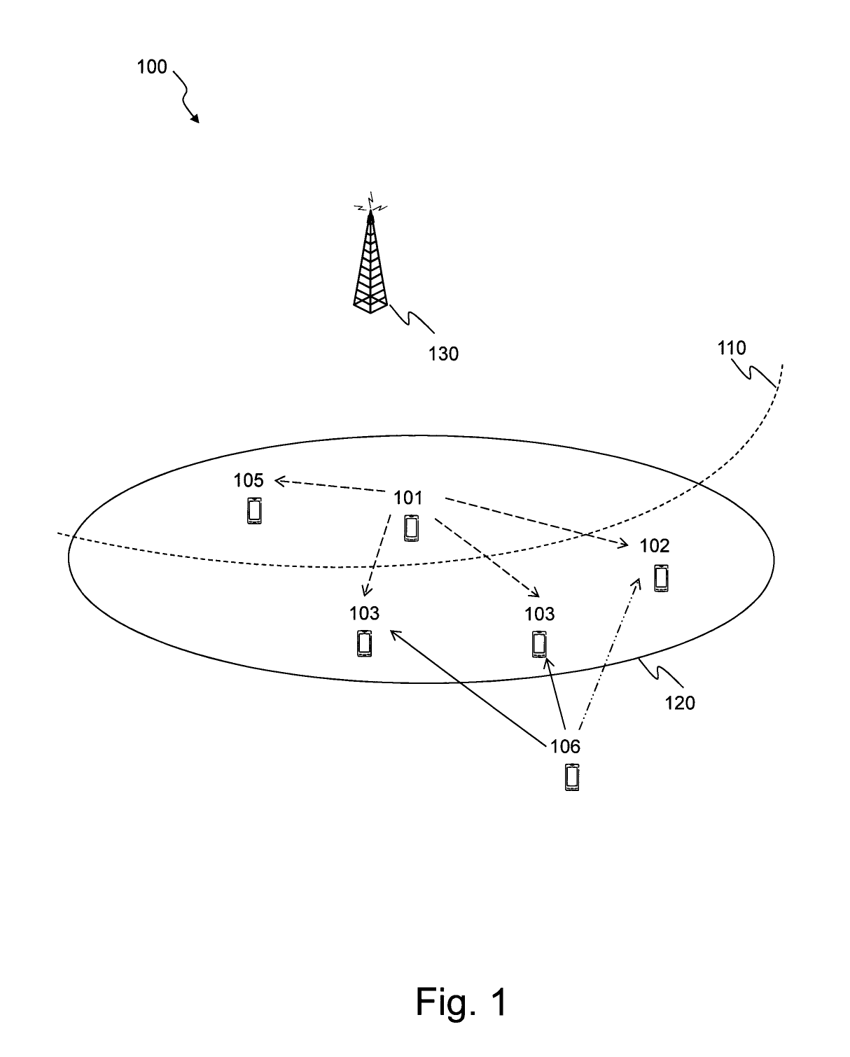

FIG. 1 illustrates a scenario 100 where a D2D device 101 transmits a synchronization signal that is received by D2D devices 102, 103 and 105, located within the radio coverage area 120 of the D2D device 101, as indicated by the dashed arrows. The D2D devices 101 and 105 also have network (NW) coverage from a radio network node 130 serving a cell 110. D2D devices 102, 103 and 106 are out of NW coverage, but D2D devices 102 and 103 are provided with NW coverage via D2D device 101 when synchronized to D2D device 101. The D2D device 106 decides to transmit a communication, e g a connectionless communication, such as broadcast of data, intended for D2D devices 103, as indicated by continuous arrows in FIG. 1, and transmits a synchronization signal to enable D2D devices 103 to synchronize to D2D device 106 to receive the communication. The synchronization signal transmitted by D2D device 106 will however also be received by other D2D devices, such as D2D device 102, which are within the radio coverage area of D2D device 106, as indicated by the dashed-and-dotted arrow in FIG. 1. D2D device 102 already has synchronization and network connection via D2D device 101 and would not benefit from re-synchronizing to D2D device 106 even if D2D device 106 appears to be better as a synchronization reference from synchronization reliability or accuracy, signal strength/quality and/or other radio characteristics point of view.

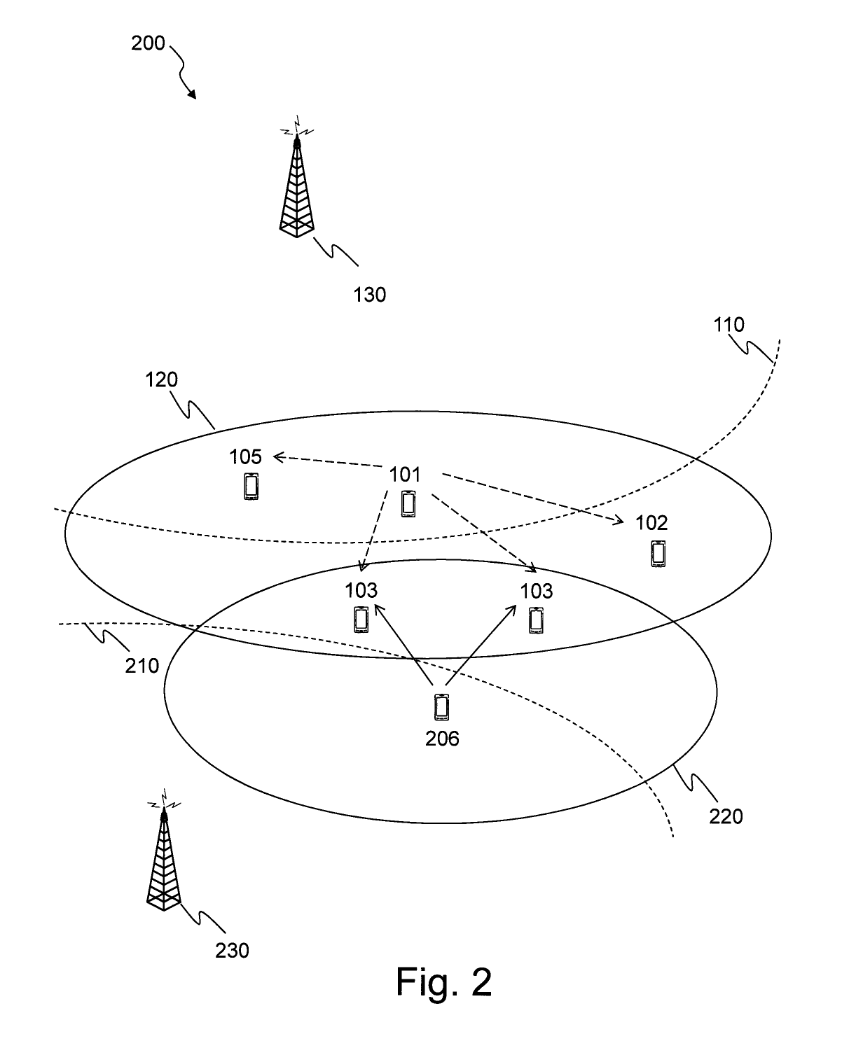

FIG. 2 illustrates a scenario 200 where a synchronization signal is transmitted by a D2D device 206, in addition to D2D device 101 transmitting a synchronization signal as illustrated in FIG. 1 and indicated by the dashed arrows also in FIG. 2. The D2D devices 103 are within the radio coverage area 220 of the D2D device 206 and receive the synchronization signal transmitted by D2D device 206, as indicated by the continuous arrows in FIG. 2. D2D device 206 also has NW coverage from a radio network node 230 serving a cell 210 and would be capable of providing D2D devices 103 with NW coverage when synchronized to D2D device 206. If D2D device 206 is determined by D2D devices 103 to be better than D2D device 101 as a synchronization reference from signal strength and/or other radio characteristics point of view, D2D devices 103 would in this case benefit from re-synchronizing to D2D device 206.

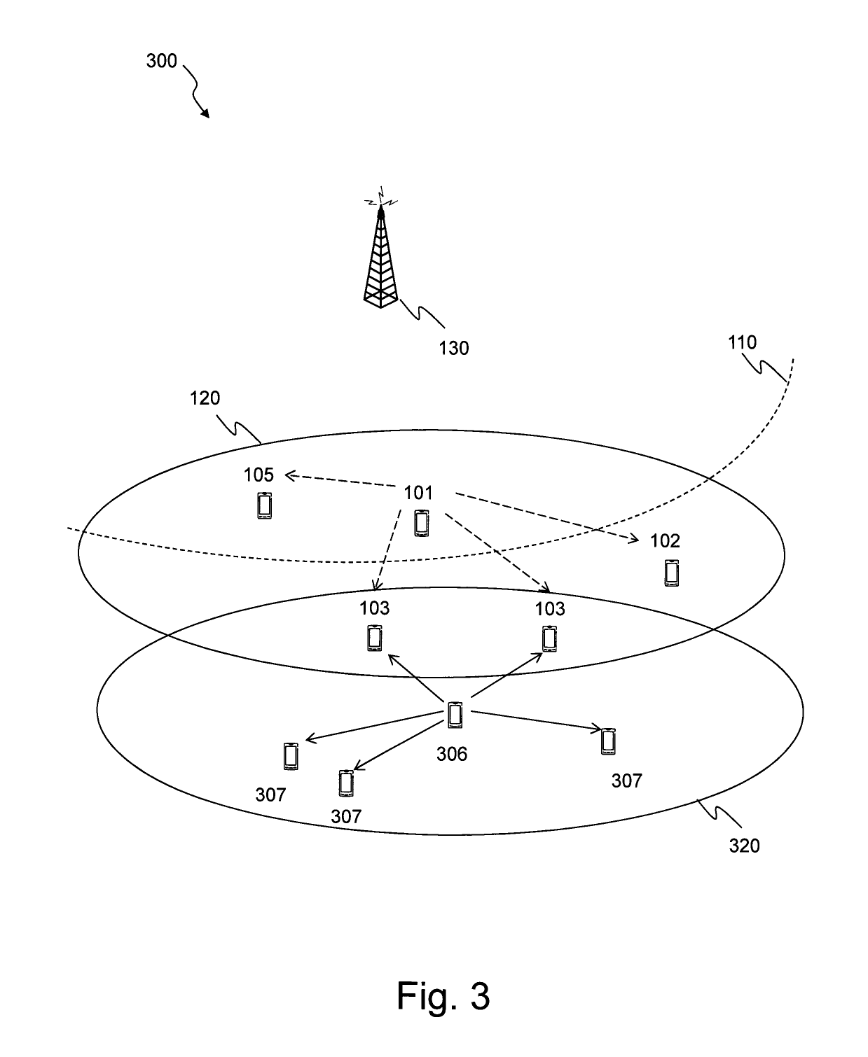

FIG. 3 illustrates a scenario 300 where a synchronization signal is transmitted by a D2D device 306, in addition to D2D device 101 transmitting a synchronization signal as illustrated in FIG. 1 and indicated by the dashed arrows also in FIG. 3. The D2D devices 103 and 307 are within the radio coverage area 320 of the D2D device 306 and receive the synchronization signal transmitted by D2D device 306, as indicated by the continuous arrows in FIG. 3. D2D device 306 is itself out of NW coverage, but it has capability to provide synchronization to other D2D devices for communication within the radio coverage area 320. If D2D devices 103 are interested in D2D communication within this area, and if D2D device 306 is determined by D2D devices 103 to fulfil requirements as a synchronization reference from synchronization reliability or accuracy, signal strength/quality and/or other radio characteristics point of view, D2D devices 103 would in this case benefit from re-synchronizing to D2D device 306.

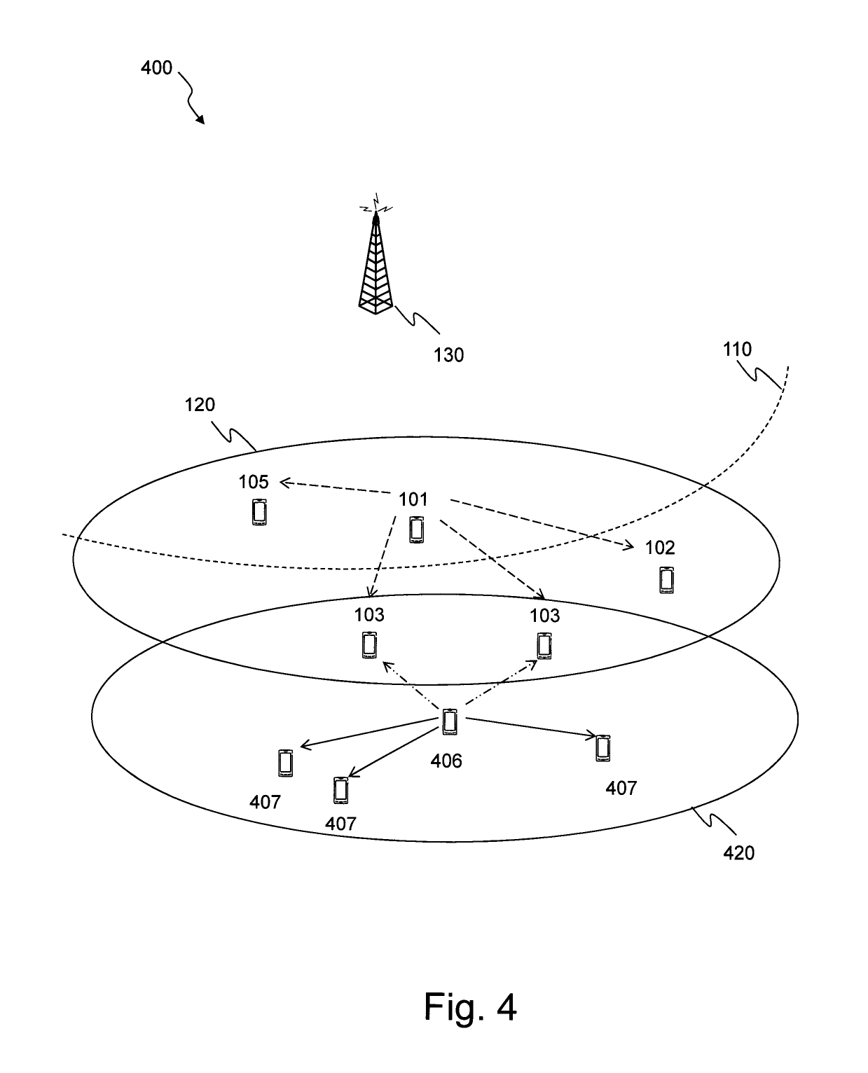

FIG. 4 illustrates a scenario 400 where a synchronization signal is transmitted by a D2D device 406, in addition to D2D device 101 transmitting a synchronization signal as illustrated in FIG. 1 and indicated by the dashed arrows also in FIG. 4. The D2D devices 103 and 407 are within the radio coverage area 420 of the D2D device 406 and receive the synchronization signal transmitted by D2D device 406. D2D device 406 transmits the synchronization signal because it needs to communicate with D2D devices 407, for example regarding an emergency situation, as indicated by the continuous arrows in FIG. 4. The signal strength of the synchronization signal sent out by the D2D device 406 may in this case be high, and may therefore appear to D2D devices 103 to be better as synchronization reference than D2D device 101 if evaluated based on signal strength. D2D devices 103 are however not targets for the communication transmitted by D2D device 406, as indicated by the dashed-and-dotted arrows in FIG. 4 and would therefore not benefit from re-synchronizing to D2D device 406.

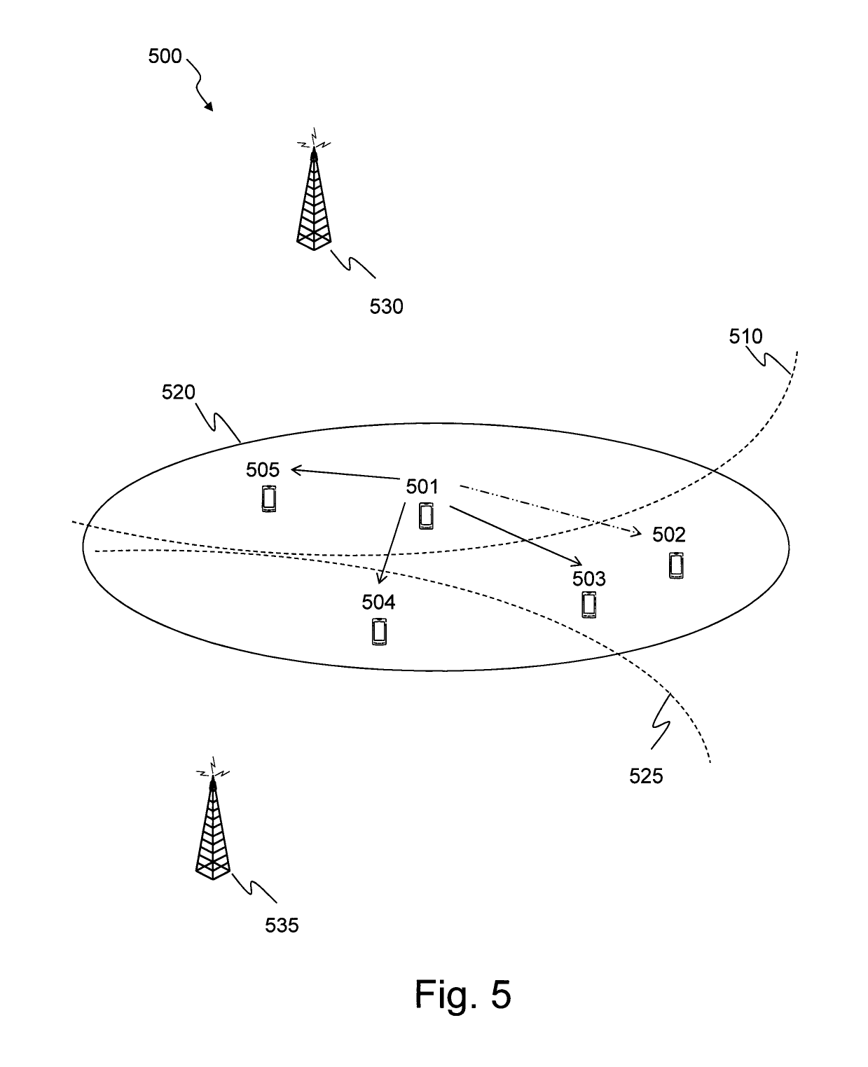

FIG. 5 illustrates a scenario 500 where D2D devices 501 and 505 have network NW coverage and thereby synchronization from a radio network node 530 serving a cell 510 and D2D device 504 has network NW coverage and thereby synchronization from a radio network node 535 serving a cell 525 whereas D2D devices 502 and 503 are out of NW coverage from cellular network. The D2D device 501 decides to transmit a communication, e g a connectionless communication, such as broadcast of data, intended for D2D devices 503, 504 and 505 as indicated by continuous arrows in FIG. 5, and transmits a synchronization signal to enable D2D devices 503, 504 and 505 to synchronize to D2D device 501 to receive the communication. The synchronization signal transmitted by D2D device 501 will however also be received by other D2D devices, such as D2D device 502, which are within the radio coverage area 520 of D2D device 501, as indicated by the dashed-and-dotted arrow in FIG. 5. In this situation, D2D device 502 cannot be provided with NW coverage via D2D device 501 and would therefore not benefit from synchronizing to this D2D device. D2D device 504 on the other hand, would need to re-synchronize to D2D device 501 in order to be able to receive the D2D communication from D2D device 501 although it already has synchronization from the cellular network, because the synchronization in the cellular network differs between cells 510 and 525.

To provide solutions for the above presented scenarios, multiple embodiments are provided, that may be used either alone or in combination.

According to one embodiment, different CH states may be defined and mapped to UE behaviours connected to synchronization. Within this disclosure any UE transmitting a synchronization signal and acting as a potential synchronization source is a CH. As a pure non exhaustive example, the following sync states or synchronization states might be considered:

1) Public sync reference CH

2) Private sync reference CH

Depending on the actions performed by the CH, a corresponding sync state is defined. Such mapping between the predetermined list of CH “sync states” and the corresponding UE behaviours may be, e.g., be defined by a standard. As an example, UEs providing a stable synchronization reference and that are willing to provide CH synchronization service to any other UEs are classified with state 1) in the above list. UEs that are providing synchronization services to a restricted number of UEs, e.g., UEs interested in a communication session, and/or that are intending to provide synchronization reference service for a limited relatively short amount of time, e.g., the duration of a communication session, are classified with state 2). With providing synchronization reference for a “relatively short amount of time” it is intended that the sync signals transmission is expected to cease earlier than what would be expected for a CH with state 1).

Out of coverage UEs that are looking for a synchronization reference may prioritize CHs with sync state 1 over CHs with sync state 2 as reference. Possibly, CHs with state 2 may not even be considered as suitable sync references except for the cases described below.

On the other hand, UEs that are interested in a communication session with a CH UE with state 2 may prioritize synchronization to the sync signals associated to such UE, even though sync signals from CHs of state 1 may be detected in proximity. This is to allow the potential receiver UE to synchronize to the correct transmitter and decode correctly the information.

Among CHs with same state or even between CHs with different states, other criteria may be considered for further selection of the most suitable sync reference, e.g., synchronization reliability, sync signal strength or quality, etc. Synchronization reliability may for example be impacted by radio conditions, accuracy of synchronization or whether a. synchronization reference is synchronized directly to an infrastructure network or over the air the interface. A synchronization reference may also be synchronized to a source external to the infrastructure network e.g. to a GPS. A synchronization reference may be synchronized to a device which is indirectly synchronized to the infrastructure network or be a synchronization reference that does not need to be synchronized to an external synchronization source.

The term synchronization is in this context referred to as time and/or carrier frequency synchronization or to any combination of time domain and frequency domain synchronization, with various level of accuracy.

In the following, a number of possible embodiments are briefly described.

A first embodiment provides means for the receiver UEs to detect the CH state based on its sync signals. According to this embodiment, sync signals are generated in such a way that the receiver is able to detect its state. E.g., different sync signal sequences and/or mapping to resources in time/frequency domains may be exploited to distinguish between sync signals for different CH states. The mapping to the CH states may be predefined in the standard.

The receiver UE is able to detect the state of the CH UE by detecting the parameters associated to the corresponding synchronization (sync) signals. E.g., a plurality of sync signal sequences (identities) may be defined and the receiver may be able to detect the transmitted sequence by comparing correlation values of the received signal with different potential sequences. Similarly, the subcarriers mapping of the sync signals may be a function of the associated CH state. Also, the time domain mapping, i.e., index of the OFDM symbols in the subframe carrying sync signals may be a function of the CH state.

In a second embodiment, an out of NW coverage UE (and, possibly, even a under NW coverage UE) performing connectionless data transmission and which does not intend to maintain the CH role indefinitely after the end of the communication session assumes the CH state 2. With “indefinitely” it is of course taken into account that the CH role may cease for events that are not directly related to the end of the communication session (e.g., the recovery of NW coverage).

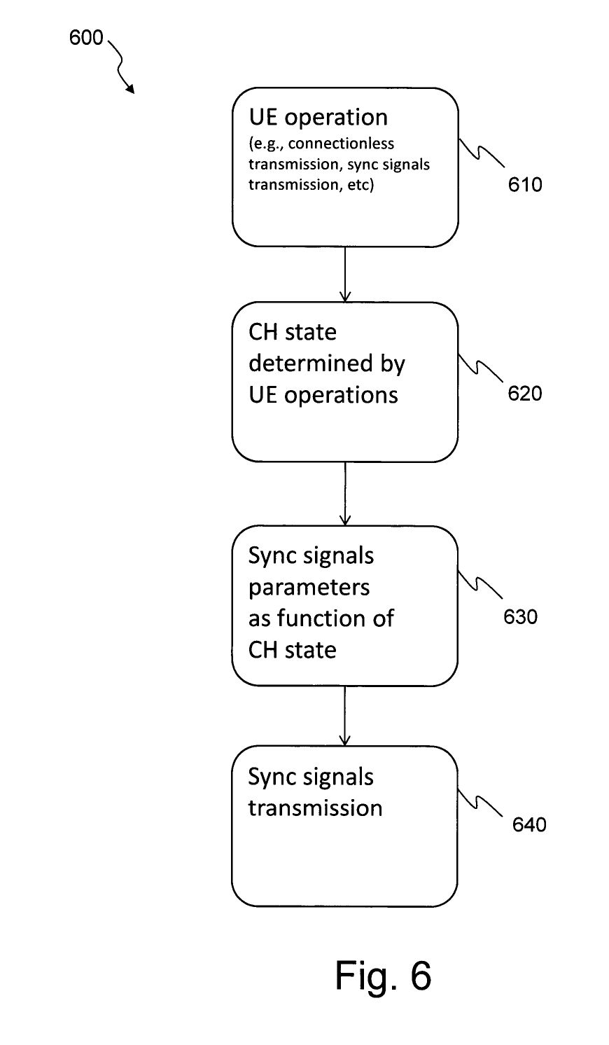

In FIG. 6 a flow chart 600 for a D2D device or UE comprising steps 610, 620, 630 and 640 for selecting a synchronization signal in accordance with an intention regarding operation as a synchronization reference or CH is shown.

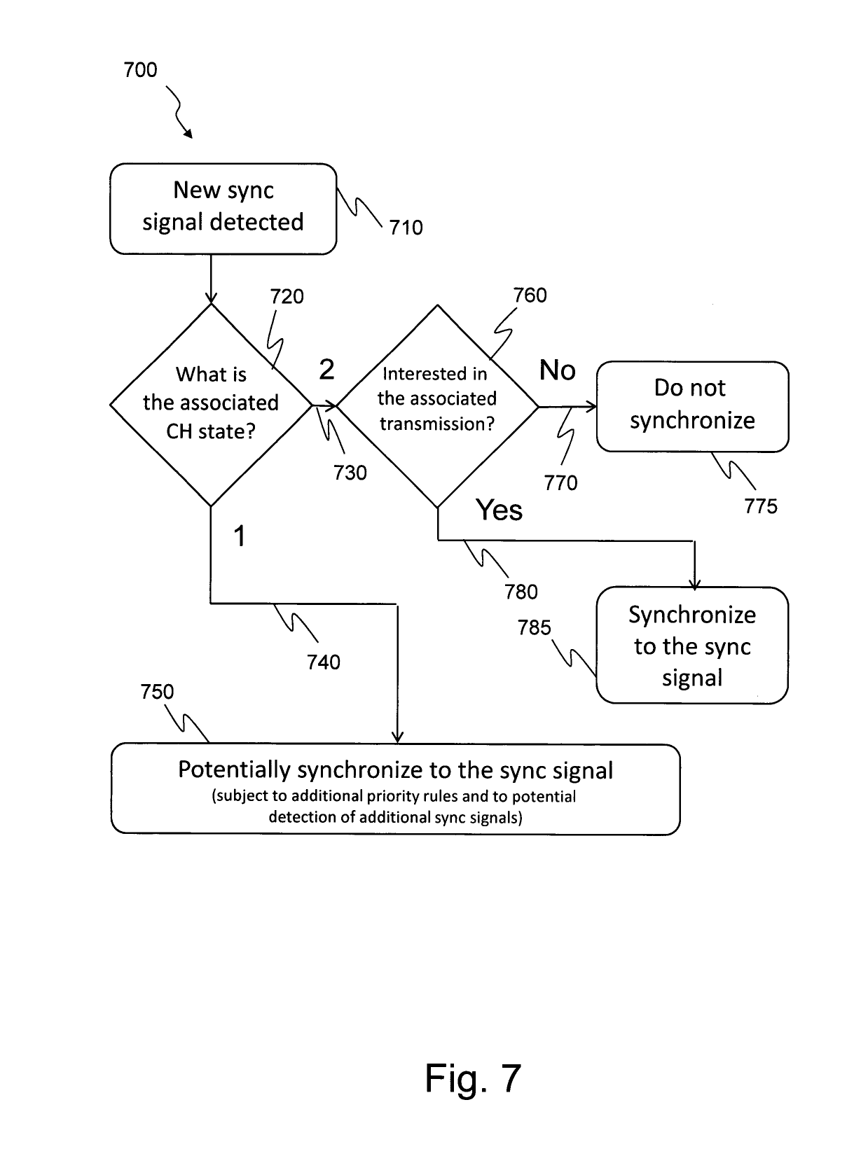

In FIG. 7 a flow chart 700 for a D2D device or UE comprising steps 710, 720, 730, 740, 750, 760, 770, 775, 780 and 785 for determining whether to synchronize to a synchronization reference or CH depending on CH state or intention to operate as a synchronization reference is shown.

The synchronization signal transmitted by a D2D device or UE in state 1) may convey that the synchronization signal is transmitted by a stable synchronization reference that intends to provide synchronization for a longer time than the duration of a communication session. The synchronization signal transmitted by D2D device or UE in state 2) may convey that a temporary synchronization signal is transmitted for the length of its communication session only.

It is observed that even UEs under NW coverage may act as CH either for providing synchronization to UEs in other cells or for other UEs that are out of NW coverage.

A CH UE which is not intending to conclude its CH role as consequence of the end of a possible communication session is a CH with state 1.

A UE which is not interested in the communication session associated to a CH state 2 shall not synchronize to the sync signals associated to such CH, even though they may be received with better signal strength or quality than other sync signals from CHs with different states.

A UE that is interested in a communication session with a CH UE with state 2 may prioritize synchronization to the sync signals associated to such UE, even though sync signals from other CHs of any state may be detected in proximity.

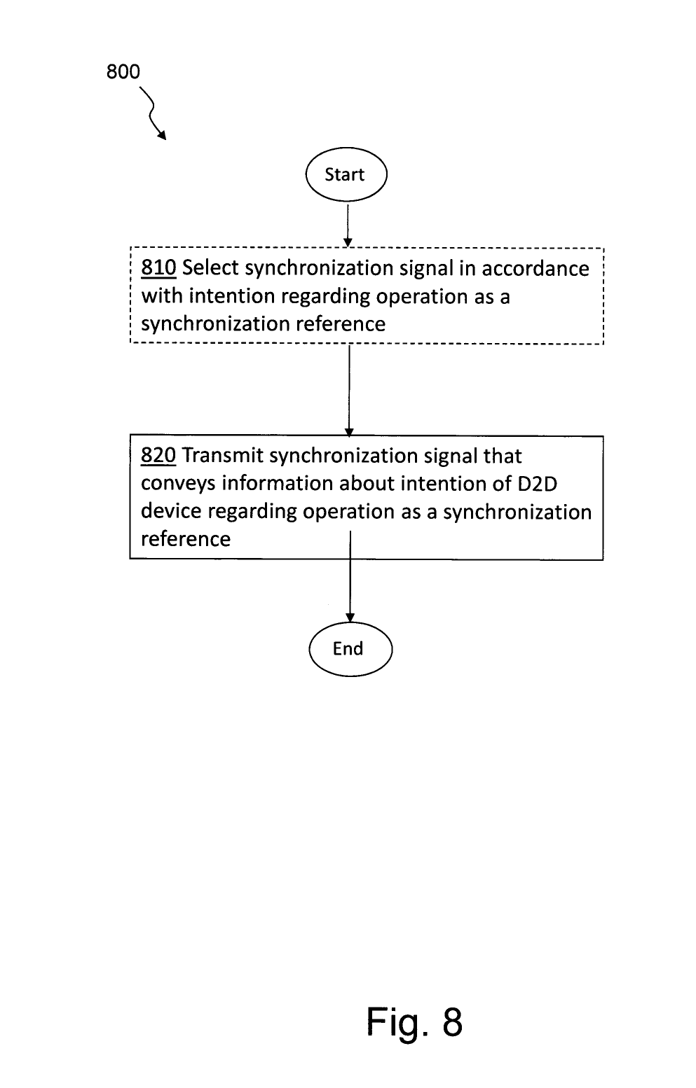

More generally, some embodiments provide a method 800 for operating as a synchronization reference will now be described with reference to FIGS. 1-5 and the flowchart of FIG. 8. A first Device-to-Device (D2D) communication enabled device 101, 106, 206, 306, 406, 501 performs the method for operating as a synchronization reference to other D2D communication enabled devices 102, 103, 105, 307, 407, 502, 503, 504, 505 that are located within radio coverage of the first D2D communication enabled device 101, 106, 206, 306, 406, 501.

According to the method 800, the first D2D communication enabled device 101, 106, 206, 306, 406, 501 may in some embodiments, in a first action 810, select a synchronization signal in accordance with an intention of the first D2D communication enabled device 101, 106, 206, 306, 406, 501 regarding operation as a synchronization reference to the other D2D communication enabled devices 102, 103, 105, 307, 407, 502, 503, 504, 505.

In an alternative embodiment, the synchronization signal is selected by a cellular network node, for example a base station such as base station 130, 230, 530 serving the first D2D communication enabled device 101, 106, 206, 306, 406, 501 or a controller node in the network, in accordance with the intention of the first D2D communication enabled device 101, 106, 206, 306, 406, 501 regarding operation as a synchronization reference by a cellular network node. According to this embodiment, the first D2D communication enabled device 101, 106, 206, 306, 406, 501 is instructed to transmit the selected synchronization signal by the cellular network node.

The first D2D communication enabled device 101, 106, 206, 306, 406, 501 then transmits, in an action 820, the synchronization signal that conveys information about the intention of the first D2D communication enabled device 101, 106, 206, 306, 406, 501 regarding operation as a synchronization reference to the other D2D communication enabled devices 102, 103, 105, 307, 407, 502, 503, 504, 505.

According to some embodiments, the information about the intention of the first D2D communication enabled device 101, 106, 206, 306, 406, 501 regarding operation as a synchronization reference may be conveyed by transmitting 820 the synchronization signal in form of a synchronization sequence selected from a set of synchronization sequences reserved for the intention regarding operation as a synchronization reference.

According to other embodiments, the information about the intention of the first D2D communication enabled device 101, 106, 206, 306, 406, 501 regarding operation as a synchronization reference may be conveyed by transmitting 820 the synchronization signal on a time/frequency resource selected from a set of time/frequency resources reserved for the intention regarding operation as a synchronization reference.

According to further embodiments, the information about the intention of the first D2D communication enabled device 101, 106, 206, 306, 406, 501 regarding operation as a synchronization reference may be conveyed by a parameter transmitted in the synchronization signal. The parameter may according to these embodiments indicate the intention of the first D2D communication enabled device 101, 106, 206, 306, 406, 501 regarding operation as a synchronization reference.

The intention of the first D2D communication enabled device 101, 106, 206, 306, 406, 501 may according to some embodiments be to operate as a synchronization reference to other D2D communication enabled devices 102, 103, 105, 307, 407, 502, 503, 504, 505 during a time that is substantially longer than a duration of a communication session involving the first D2D communication enabled device 101, 106, 206, 306, 406, 501. The first D2D communication enabled device 101, 106, 206, 306, 406, 501 may in some of these embodiments provide synchronization to enable the other D2D communication enabled devices 102, 103, 105, 307, 407, 502, 503, 504, 505 to communicate with each other directly via D2D communication. The other D2D communication enabled devices 102, 103, 105, 307, 407, 502, 503, 504, 505 may use D2D communication regardless of whether they are within or out of coverage of a cellular network. In further embodiments, the first D2D communication enabled device 101, 106, 206, 306, 406, 501 may in addition provide connection to the cellular network for those of the other D2D communication enabled devices 102, 103, 105, 307, 407, 502, 503, 504, 505 that are out of coverage of the cellular network.

In alternative embodiments, the intention of the first D2D communication enabled device 101, 106, 206, 306, 406, 501 may be to operate as a synchronization reference to other D2D communication enabled devices 102, 103, 105, 307, 407, 502, 503, 504, 505 during a time that is substantially equal to a duration of a communication session involving the first D2D communication enabled device 101, 106, 206, 306, 406, 501. The communication transmitted by the first D2D communication enabled device 101, 106, 206, 306, 406, 501 may in one example be connectionless communication.

According to further embodiments the intention of the first D2D communication enabled device 101, 106, 206, 306, 406, 501 regarding operation as a synchronization reference may be to operate as a public cluster head that transmits synchronization signals and intends to provide synchronization to other D2D communication enabled devices 102, 103, 105, 307, 407, 502, 503, 504, 505 that are not necessarily targets of communication transmitted by the first D2D communication enabled device 101, 106, 206, 306, 406, 501.

According to further alternative embodiments the intention of the first D2D communication enabled device 101, 106, 206, 306, 406, 501 regarding operation as a synchronization reference may to operate as a private cluster head that transmits synchronization signals and intends to provide synchronization only to those of the other D2D communication enabled devices 102, 103, 105, 307, 407, 502, 503, 504, 505 that are targets of communication transmitted by the first D2D communication enabled device 101, 106, 206, 306, 406, 501.

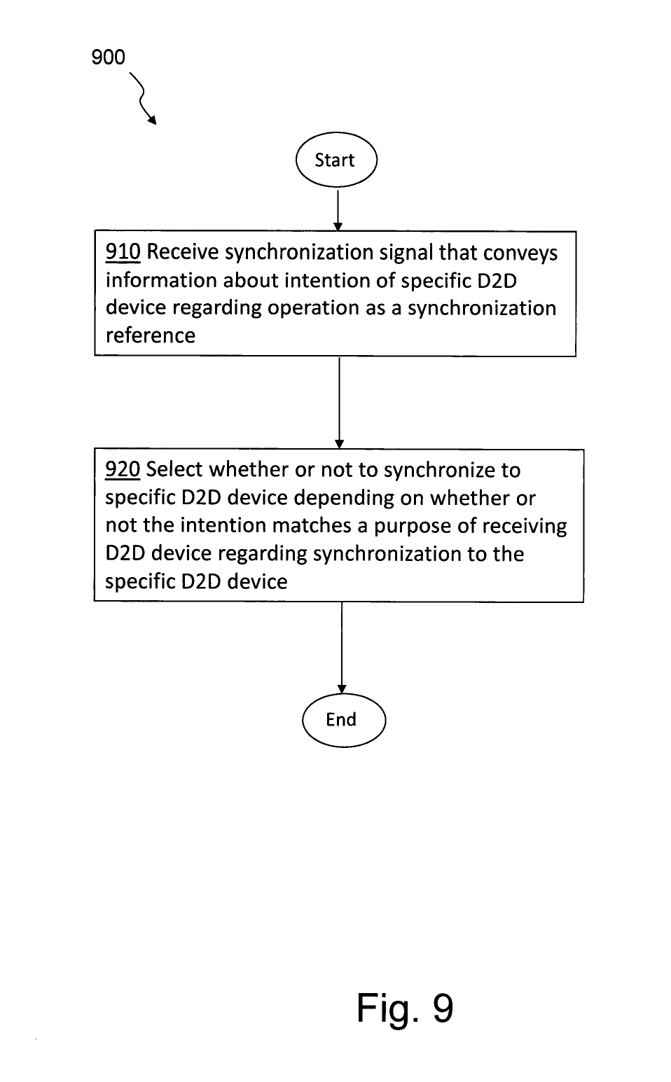

Further embodiments that provide a method 900 for selectively synchronizing to a synchronization reference will now be described with reference to FIGS. 1-5 and the flowchart of FIG. 9. A receiving Device-to-Device (D2D) communication enabled device 102, 103, 502, 504 performs the method for selectively synchronizing to a specific D2D communication enabled device 106, 206, 306, 406, 501.

According to the method 900, the receiving D2D communication enabled device 102, 103, 502, 504 receives, in a first action 910, a synchronization signal that conveys information about an intention of the specific D2D communication enabled device 106, 206, 306, 406, 501 regarding operation as a synchronization reference to other D2D communication enabled devices 102, 103, 105, 307, 407, 502, 503, 504, 505.

The receiving D2D communication enabled device 102, 103, 502, 504 then selectively synchronizes, in an action 920, to the specific D2D communication enabled device 106, 206, 306, 406, 501 depending on whether the intention of the specific D2D communication enabled device 106, 206, 306, 406, 501 is in agreement with a purpose of the receiving D2D communication enabled device 102, 103, 502, 504 regarding obtaining synchronization from the specific D2D communication enabled device 106, 206, 306, 406, 501.

According to some embodiments, the receiving D2D communication enabled device 102, 103, 502, 504 selectively synchronizes 920 to the specific D2D communication enabled device 106, 206, 306, 406, 501 by abstaining from synchronizing to the specific D2D communication enabled device 106, 206, 306, 406, 501 when the intention of the specific D2D communication enabled device 106, 206, 306, 406, 501 is not in agreement with the purpose of the receiving D2D communication enabled device 102, 103, 502, 504.

Alternatively or additionally, the receiving D2D communication enabled device 102, 103, 502, 504 may selectively synchronize 920 to the specific D2D communication enabled device 106, 206, 306, 406, 501 by synchronizing to the specific D2D communication enabled device 106, 206, 306, 406, 501 when the intention of the specific D2D communication enabled device 106, 206, 306, 406, 501 is in agreement with the purpose of the receiving D2D communication enabled device 102, 103, 502, 504.

In a further addition or alternative, the receiving D2D communication enabled device 102, 103, 502, 504 may selectively synchronize 920 to the specific D2D communication enabled device 106, 206, 306, 406, 501 by synchronizing to the specific D2D communication enabled device 106, 206, 306, 406, 501 when the intention of the specific D2D communication enabled device 106, 206, 306, 406, 501 is in agreement with the purpose of the receiving D2D communication enabled device 102, 103, 502, 504 provided that an evaluation of further criteria indicates a preference of obtaining synchronization from the specific D2D communication enabled device 106, 206, 306, 406, 501 over obtaining synchronization from another D2D communication enabled device 101 that is currently operating as synchronization reference for the receiving D2D communication enabled device 102, 103, 502, 504. The further criteria may in one example comprise at least one of synchronization reliability or accuracy, signal strength of the synchronization signal and signal quality of the synchronization signal.

According to further embodiments, the intention of the specific D2D communication enabled device 106, 206, 306, 406, 501 is in agreement with the purpose of the receiving D2D communication enabled device 102, 103, 502, 504 when the intention of the specific D2D communication enabled device 106, 206, 306, 406, 501 regarding operation as a synchronization reference meets a requirement of the receiving D2D communication enabled device 102, 103, 502, 504 regarding obtaining synchronization from the specific D2D communication enabled device 106, 206, 306, 406, 501.

The requirement of the receiving D2D communication enabled device 102, 103, 502, 504 may in one example be to obtain synchronization from a stable synchronization reference. In this example, the intention of the specific D2D communication enabled device 106, 206, 306, 406, 501 regarding operation as a synchronization reference meets the requirement of the receiving D2D communication enabled device 102, 103, 502, 504 when the intention of the specific D2D communication enabled device 106, 206, 306, 406, 501 is to operate as a synchronization reference to other D2D communication enabled devices 102, 103, 105, 307, 407, 502, 503, 504, 505 during a time that is substantially longer than a duration of a communication session involving the specific D2D communication enabled device 106, 206, 306, 406, 501. The receiving D2D communication enabled device 102, 103, 502, 504 may in some embodiments be out of coverage of a cellular network. The receiving D2D communication enabled device 102, 103, 502, 504 may then according to these embodiments obtain connection to the cellular network via the specific D2D communication enabled device 106, 206, 306, 406, 501 by synchronizing to the specific D2D communication enabled device 106, 206, 306, 406, 501.

According to an alternative example, the requirement of the receiving D2D communication enabled device 102, 103, 502, 504 may be to obtain synchronization for receiving a communication from the specific D2D communication enabled device 106, 206, 306, 406, 501 in a communication session. In this example, the intention of the specific D2D communication enabled device 106, 206, 306, 406, 501 regarding operation as a synchronization reference meets the requirement of the receiving D2D communication enabled device 102, 103, 502, 504 when the intention of the specific D2D communication enabled device 106, 206, 306, 406, 501 is to operate as a synchronization reference to other D2D communication enabled devices 102, 103, 105, 307, 407, 502, 503, 504, 505 during a time that is substantially equal to a duration of a communication session involving the specific D2D communication enabled device 106, 206, 306, 406, 501. In one example, the communication transmitted by the specific D2D communication enabled device 106, 206, 306, 406, 501 may be a connectionless communication.

In some embodiments according to the above alternative example, the receiving D2D communication enabled device 102, 103, 502, 504 may be connected to a first cell 525 of a cellular network and the specific D2D communication enabled device 106, 206, 306, 406, 501 may be connected to a second cell 510 of the cellular network. According to these embodiments the receiving D2D communication enabled device 102, 103, 502, 504 may select to synchronize to the specific D2D communication enabled device 106, 206, 306, 406, 501 in order to receive the communication from the specific D2D communication enabled device 106, 206, 306, 406, 501 in the communication session.

According to further embodiments the receiving D2D communication enabled device 102, 103, 502, 504 may prioritize to obtain synchronization from the specific D2D communication enabled device 106, 206, 306, 406, 501 over obtaining synchronization from another D2D communication enabled device 101 when the intention of the specific D2D communication enabled device 106, 206, 306, 406, 501 is in agreement with the purpose of the receiving D2D communication enabled device 102, 103, 502, 504, although at least one other criterion indicates preference of the another D2D communication enabled device 101 for obtaining synchronization. Furthermore, when the intention of the specific D2D communication enabled device 106, 206, 306, 406, 501 is not in agreement with the purpose of the receiving D2D communication enabled device 102, 103, 502, 504, the receiving D2D communication enabled device 102, 103, 502, 504 may abstain from synchronizing to the specific D2D communication enabled device 106, 206, 306, 406, 501 regardless of whether the at least one other criterion indicates preference of the specific D2D communication enabled device 106, 206, 306, 406, 501 for obtaining synchronization. The at least one other criterion may comprise at least one of synchronization reliability or accuracy, signal strength of the synchronization signal and signal quality of the synchronization signal.

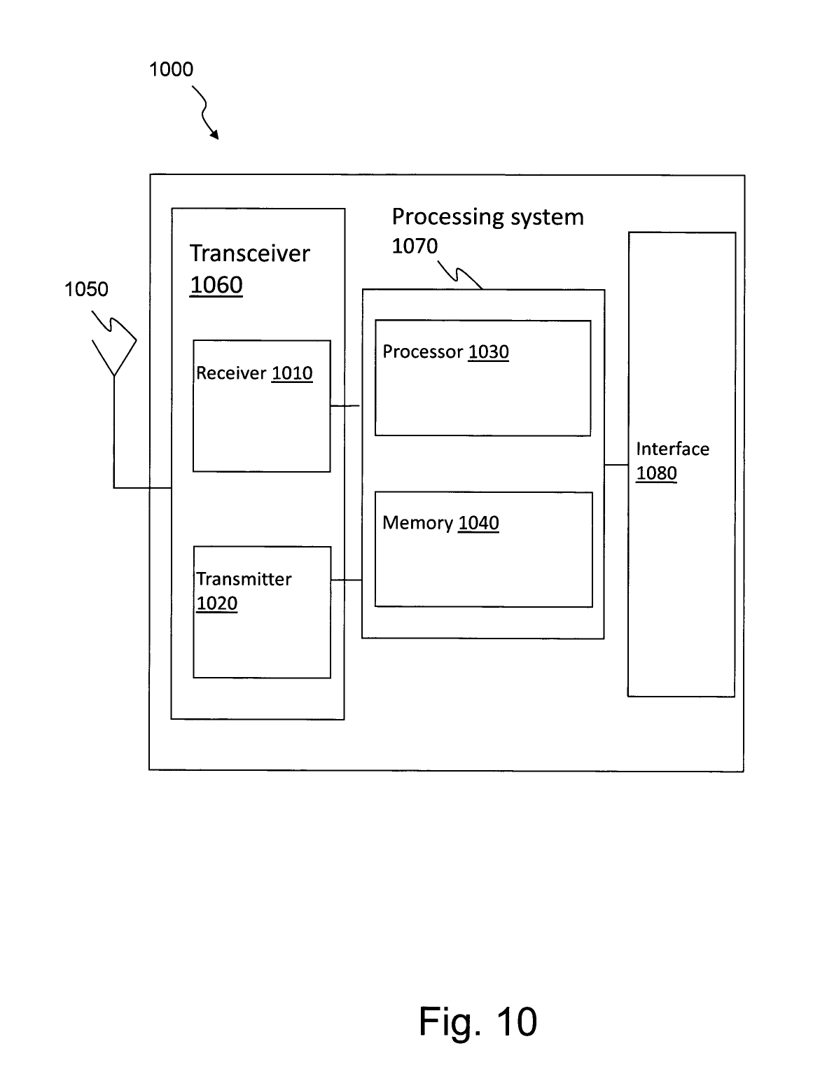

FIG. 10 illustrates a D2D communication enabled device 1000 that may be configured to perform the method 800 operating as the first D2D communication enabled device 101, 106, 206, 306, 406, 501 and/or the method 900 operating as the receiving D2D communication enabled device 102, 103, 502, 504. The D2D communication enabled device 1000 comprises a transceiver 1060 connected to an antenna arrangement which may comprise one or more antennas 1050. The transceiver 1060 comprises a receiver 1010 configured to receive radio communications via the one or more antennas 1050 and a transmitter 1020 configured to transmit radio communications via the one or more antennas 1050. The receiver 1010 and transmitter 1020 may alternatively be implemented as separate units not part of any transceiver. The D2D communication enabled device 1000 further comprises a processor 1030 operatively connected to the receiver 1010 and transmitter 1020 and configured to control the receiver 1010 and transmitter 1020 to receive and transmit radio communications via the one or more antennas 1050 and a memory 1040 configured to store software to be executed by, for example, the processor 1030. The memory 1040 is configured to be accessible by thee processor 1030 and may comprise instructions to enable the processor 1030 to perform the methods 800 and/or 900.

The processor 1030 may be implemented as a processing unit, a processing circuit, an application specific integrated circuit (ASIC), a field-programmable gate array (FPGA), a Digital Signal Processor (DSP) or the like. As an example, a processor, an ASIC, an FPGA, a DSP or the like may comprise one or more processor kernels. The memory 1040 may be implemented as a hard disk, a magnetic storage medium, a portable computer diskette or disc, flash memory, random access memory (RAM) or the like. Furthermore, the memory may be an internal register memory of the processor 1030. The processor 1030 and memory 1040 may be comprised in a processing system 1070.

The D2D communication enabled device 1000 may be a User Equipment that is, in addition to being configured to perform D2D communication with other D2D communication enabled devices, also configured to communicate with a cellular radio communications network. Alternatively, in some embodiments, the D2D communication enabled device 1000 may be a network node in the cellular radio communications network. For such embodiments the D2D communication enabled device 1000 may comprise an interface 1080 which may be different depending on whether the D2D device is a UE or a network node.

To perform the method 800, the the processor 1030 may in some embodiments be configured to select the synchronization signal in accordance with the intention of the first D2D communication enabled device 1000; 101, 106, 206, 306, 406, 501 regarding operation as a synchronization reference to the other D2D communication enabled devices 102, 103, 105, 307, 407, 502, 503, 504, 505 that are located within radio coverage of the first D2D communication enabled device 1000; 101, 106, 206, 306, 406, 501.

In an alternative embodiment, the synchronization signal is selected by a cellular network node and the first D2D communication enabled device 101, 106, 206, 306, 406, 501 is in this embodiment configured to be instructed by the cellular network node to transmit the selected synchronization signal.

To perform the method 800, the transmitter is 1020 configured to transmit the synchronization signal as instructed by the processor 1030. The synchronization signal conveys information about an intention of the first D2D communication enabled device 1000; 101, 106, 206, 306, 406, 501 regarding operation as a synchronization reference to the other D2D communication enabled devices 102, 103, 105, 307, 407, 502, 503, 504, 505.

According to some embodiments, the transmitter 1020 may be configured to convey the information about the intention of the first D2D communication enabled device 1000; 101, 106, 206, 306, 406, 501 regarding operation as a synchronization reference in form of a synchronization sequence selected from a set of synchronization sequences reserved for the intention regarding operation as a synchronization reference.

According to other embodiments, the transmitter 1020 may be configured to convey the information about the intention of the first D2D communication enabled device 1000; 101, 106, 206, 306, 406, 501 regarding operation as a synchronization reference by transmitting the synchronization signal on a time/frequency resource selected from a set of time/frequency resources reserved for the intention regarding operation as a synchronization reference.

According to further embodiments, the transmitter 1020 may be configured to convey the information about the intention of the first D2D communication enabled device 1000; 101, 106, 206, 306, 406, 501 regarding operation as a synchronization reference by a parameter transmitted in the synchronization signal. The parameter may according to these embodiments indicate the intention of the first D2D communication enabled device 1000; 101, 106, 206, 306, 406, 501 regarding operation as a synchronization reference.

As stated above in the description of the method 800, the intention of the first D2D communication enabled device 1000; 101, 106, 206, 306, 406, 501 may according to some embodiments be to operate as a synchronization reference to other D2D communication enabled devices 102, 103, 105, 307, 407, 502, 503, 504, 505 during a time that is substantially longer than a duration of a communication session involving the first D2D communication enabled device 1000; 101, 106, 206, 306, 406, 501. The first D2D communication enabled device 1000; 101, 106, 206, 306, 406, 501 may in some of these embodiments further be configured to provide synchronization to enable the other D2D communication enabled devices 102, 103, 105, 307, 407, 502, 503, 504, 505 to communicate with each other directly via D2D communication. The other D2D communication enabled devices 102, 103, 105, 307, 407, 502, 503, 504, 505 may use D2D communication regardless of whether they are within or out of coverage of a cellular network. In further embodiments, the first D2D communication enabled device 101, 106, 206, 306, 406, 501 may in addition be configured to provide connection to the cellular network for those of the other D2D communication enabled devices 102, 103, 105, 307, 407, 502, 503, 504, 505 that are out of coverage of the cellular network.

As further stated above in the description of the method 800, the intention of the first D2D communication enabled device 1000; 101, 106, 206, 306, 406, 501 may in alternative embodiments be to operate as a synchronization reference to other D2D communication enabled devices 102, 103, 105, 307, 407, 502, 503, 504, 505 during a time that is substantially equal to a duration of a communication session involving the first D2D communication enabled device 1000; 101, 106, 206, 306, 406, 501. The first D2D communication enabled device 1000; 101, 106, 206, 306, 406, 501 may in one example be configured to perform connectionless communication during the communication session.

The first D2D communication enabled device 1000; 101, 106, 206, 306, 406, 501 be configured to operate as a public cluster head, or alternatively, as a private cluster head for a cluster of other D2D communication enabled devices 102, 103, 105, 307, 407, 502, 503, 504, 505. The intention conveyed in the synchronization signal may then correspond to the configuration as a public or private cluster head, as stated above in the description of the method 800.

To perform the method 900, the receiver 1010 is configured to receive a synchronization signal that conveys information about an intention of the specific D2D communication enabled device 106, 206, 306, 406, 501 regarding operation as a synchronization reference to other D2D communication enabled devices 102, 103, 105, 307, 407, 502, 503, 504, 505.

In addition, the processor 1030 is configured to selectively synchronize to the specific D2D communication enabled device 106, 206, 306, 406, 501 depending on whether the intention of the specific D2D communication enabled device 106, 206, 306, 406, 501 is in agreement with a purpose of the receiving D2D communication enabled device 1000; 102, 103, 502, 504 regarding obtaining synchronization from the specific D2D communication enabled device 106, 206, 306, 406, 501.

According to some embodiments, the processor 1030 is configured to selectively synchronize to the specific D2D communication enabled device 106, 206, 306, 406, 501 by further being configured to abstain from synchronizing to the specific D2D communication enabled device 106, 206, 306, 406, 501 when the intention of the specific D2D communication enabled device 106, 206, 306, 406, 501 is not in agreement with the purpose of the receiving D2D communication enabled device 1000; 102, 103, 502, 504.

Alternatively or additionally, the processor 1030 may be configured to selectively synchronize to the specific D2D communication enabled device 106, 206, 306, 406, 501 by further being configured to synchronize to the specific D2D communication enabled device 106, 206, 306, 406, 501 when the intention of the specific D2D communication enabled device 106, 206, 306, 406, 501 is in agreement with the purpose of the receiving D2D communication enabled device 1000; 102, 103, 502, 504.

In a further addition or alternative, the processor 1030 may be configured to selectively synchronize to the specific D2D communication enabled device 106, 206, 306, 406, 501 by further being configured to synchronize to the specific D2D communication enabled device 106, 206, 306, 406, 501 when the intention of the specific D2D communication enabled device 106, 206, 306, 406, 501 is in agreement with the purpose of the receiving D2D communication enabled device 1000; 102, 103, 502, 504 provided that an evaluation of further criteria indicates a preference of obtaining synchronization from the specific D2D communication enabled device 106, 206, 306, 406, 501 over obtaining synchronization from another D2D communication enabled device 101 that is currently operating as synchronization reference for the receiving D2D communication enabled device 1000; 102, 103, 502, 504. The further criteria may in one example comprise at least one of synchronization reliability or accuracy, signal strength of the synchronization signal and signal quality of the synchronization signal.

According to further embodiments, the intention of the specific D2D communication enabled device 106, 206, 306, 406, 501 is in agreement with the purpose of the receiving D2D communication enabled device 1000; 102, 103, 502, 504 when the intention of the specific D2D communication enabled device 106, 206, 306, 406, 501 regarding operation as a synchronization reference meets a requirement of the receiving D2D communication enabled device 1000; 102, 103, 502, 504 regarding obtaining synchronization from the specific D2D communication enabled device 106, 206, 306, 406, 501.

As mentioned in the above description of the method 900, the requirement of the receiving D2D communication enabled device 1000; 102, 103, 502, 504 may in one example be to obtain synchronization from a stable synchronization reference. In this example, the intention of the specific D2D communication enabled device 106, 206, 306, 406, 501 regarding operation as a synchronization reference meets the requirement of the receiving D2D communication enabled device 1000; 102, 103, 502, 504 when the intention of the specific D2D communication enabled device 106, 206, 306, 406, 501 is to operate as a synchronization reference to other D2D communication enabled devices 102, 103, 105, 307, 407, 502, 503, 504, 505 during a time that is substantially longer than a duration of a communication session involving the specific D2D communication enabled device 106, 206, 306, 406, 501. The receiving D2D communication enabled device 1000; 102, 103, 502, 504 may in some embodiments be out of coverage of a cellular network. The processor 1030 may then according to these embodiments be configured to obtain connection to the cellular network via the specific D2D communication enabled device 106, 206, 306, 406, 501 by synchronizing to the specific D2D communication enabled device 106, 206, 306, 406, 501.

Further, according to an alternative example also mentioned in the above description of the method 900, the requirement of the receiving D2D communication enabled device 1000; 102, 103, 502, 504 may be to obtain synchronization for receiving a communication from the specific D2D communication enabled device 106, 206, 306, 406, 501 in a communication session. In this example, the intention of the specific D2D communication enabled device 106, 206, 306, 406, 501 regarding operation as a synchronization reference meets the requirement of the receiving D2D communication enabled device 1000; 102, 103, 502, 504 when the intention of the specific D2D communication enabled device 106, 206, 306, 406, 501 is to operate as a synchronization reference to other D2D communication enabled devices 102, 103, 105, 307, 407, 502, 503, 504, 505 during a time that is substantially equal to a duration of a communication session involving the specific D2D communication enabled device 106, 206, 306, 406, 501. In one example, the communication transmitted by the specific D2D communication enabled device 106, 206, 306, 406, 501 may be a connectionless communication.

In some embodiments according to the above alternative example, the receiving D2D communication enabled device 1000; 102, 103, 502, 504 may be connected to a first cell 525 of a cellular network and the specific D2D communication enabled device 106, 206, 306, 406, 501 may be connected to a second cell 510 of the cellular network. According to these embodiments the processor 1030 may be configured to select to synchronize to the specific D2D communication enabled device 106, 206, 306, 406, 501 in order to receive the communication from the specific D2D communication enabled device 106, 206, 306, 406, 501 in the communication session.

According to further embodiments the processor 1030 may be configured to prioritize to obtain synchronization from the specific D2D communication enabled device 106, 206, 306, 406, 501 over obtaining synchronization from another D2D communication enabled device 101 when the intention of the specific D2D communication enabled device 106, 206, 306, 406, 501 is in agreement with the purpose of the receiving D2D communication enabled device 1000; 102, 103, 502, 504, although at least one other criterion indicates preference of the another D2D communication enabled device 101 for obtaining synchronization. Furthermore, when the intention of the specific D2D communication enabled device 106, 206, 306, 406, 501 is not in agreement with the purpose of the receiving D2D communication enabled device 1000; 102, 103, 502, 504, the processor 1030 may be configured to abstain from synchronizing to the specific D2D communication enabled device 106, 206, 306, 406, 501 regardless of whether the at least one other criterion indicates preference of the specific D2D communication enabled device 106, 206, 306, 406, 501 for obtaining synchronization. The at least one other criterion may comprise at least one of synchronization reliability or accuracy, signal strength of the synchronization signal and signal quality of the synchronization signal.

As an alternative to the configuration depicted in FIG. 10, the D2D communication enabled device 1000 may include several functional units which may be implemented in hardware, software, firmware or any combination thereof. In an embodiment for performing method 800 the D2D communication enabled device 1000 may include a transmitting unit for transmitting the synchronization signal that conveys information about an intention of the D2D communication enabled device 1000 regarding operation as a synchronization reference and an instructing unit for instructing the transmitting unit to transmit the synchronization signal. The D2D communication enabled device 1000 may further optionally in some embodiments include a selecting unit for selecting the synchronization signal in accordance with the intention of the D2D communication enabled device 1000.

In an embodiment for performing method 900 the D2D communication enabled device 1000 operating as the receiving D2D communication enabled device of method 900 may include a receiving unit for receiving the synchronization signal that conveys information about an intention of the specific D2D communication enabled device 1000 regarding operation as a synchronization reference and a synchronizing unit and/or a selecting unit for selectively synchronizing to the specific D2D communication enabled device depending on whether the intention of the specific D2D communication enabled device is in agreement with a purpose of the receiving D2D communication enabled device regarding obtaining synchronization from the specific D2D communication enabled device.

The terminology UE includes, but should not be limited to, a mobile station, a fixed or mobile subscriber unit, a pager, a cellular telephone, a personal digital assistant (PDA), a computer, or any other type of user device capable of operating in a wireless communication. The terminology network node includes a radio base station, a eNB, a eNodeB, an access point or any suitable network node.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. In particular, it should be noted that although terminology from 3GPP LTE has been used in this disclosure to exemplify the invention, this should not be seen as limiting the scope of the invention to only the aforementioned system. Other wireless systems, including LTE-A (or LTE-Advanced), UMTS, WiMax, and wireless LAN, may also benefit from exploiting the ideas covered within this disclosure.

In addition, the described embodiments may be realised in many ways. For example, an embodiment includes a computer-readable medium having instructions stored thereon that are executable by a computer system located in one or several devices being UE(s) or network node(s) of the communication system, for selectively synchronizing to a synchronization reference or transmitting a synchronization signal that conveys information about an intention regarding operation as a synchronization reference. The instructions executable by the computing system and stored on the computer-readable medium perform the method steps of the present embodiments as set forth in the claims.

While the invention has been described in terms of several preferred embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the present invention.

1-26. (canceled)

27. A method, performed by a first Device-to-Device (D2D) communication enabled device, for operating as a synchronization reference to other D2D communication enabled devices located within radio coverage of the first D2D communication enabled device, the method comprising:
transmitting a synchronization signal that conveys information about an intention of the first D2D communication enabled device regarding operation as a synchronization reference to the other D2D communication enabled devices.

28. The method according to claim 27, wherein the information about the intention of the first D2D communication enabled device regarding operation as a synchronization reference is conveyed by transmitting the synchronization signal in form of a synchronization sequence selected from a set of synchronization sequences reserved for the intention regarding operation as a synchronization reference.

29. The method according to claim 27, wherein the information about the intention of the first D2D communication enabled device regarding operation as a synchronization reference is conveyed by transmitting the synchronization signal on a time/frequency resource selected from a set of time/frequency resources reserved for the intention regarding operation as a synchronization reference.

30. The method according to claim 27, wherein the information about the intention of the first D2D communication enabled device regarding operation as a synchronization reference is conveyed by a parameter transmitted in the synchronization signal, which parameter indicates the intention regarding operation as a synchronization reference.

31. The method according to claim 27, wherein the intention of the first D2D communication enabled device is to operate as a synchronization reference to other D2D communication enabled devices during a time that is substantially longer than a duration of a communication session involving the first D2D communication enabled device.

32. The method according to claim 31, wherein the first D2D communication enabled device further provides connection to a cellular network for those of the other D2D communication enabled devices that are out of coverage of the cellular network.

33. The method according to claim 31, wherein the first D2D communication enabled device provides synchronization to enable the other D2D communication enabled devices to communicate with each other regardless of whether they are within or out of coverage of the cellular network.

34. The method according to claim 27, wherein the intention of the first D2D communication enabled device is to operate as a synchronization reference to other D2D communication enabled devices during a time that is substantially equal to a duration of a communication session involving the first D2D communication enabled device.

35. The method according to claim 34, wherein the communication transmitted by the first D2D communication enabled device is a connectionless communication.

36. The method according to claim 27, wherein the intention of the first D2D communication enabled device regarding operation as a synchronization reference is to operate as a public cluster head that transmits synchronization signals and intends to provide synchronization to other D2D communication enabled devices that are not necessarily targets of communication transmitted by the first D2D communication enabled device.

37. The method according to claim 27, wherein the intention of the first D2D communication enabled device regarding operation as a synchronization reference is to operate as a private cluster head that transmits synchronization signals and intends to provide synchronization only to those of the other D2D communication enabled devices that are targets of communication transmitted by the first D2D communication enabled device.

38. The method according to claim 27, wherein the method further comprises selecting the synchronization signal in accordance with the intention of the first D2D communication enabled device regarding operation as a synchronization reference to the other D2D communication enabled devices.

39. The method according to claim 27, wherein the synchronization signal is selected in accordance with the intention of the first D2D communication enabled device regarding operation as a synchronization reference by a cellular network node and wherein the first D2D communication enabled device is instructed to transmit the selected synchronization signal by the cellular network node.

40. A first Device-to-Device (D2D) communication enabled device for operating as a synchronization reference to other D2D communication enabled devices located within radio coverage of the first D2D communication enabled device, the first D2D communication enabled device comprising:
a transmitter configured to transmit a synchronization signal that conveys information about an intention of the first D2D communication enabled device regarding operation as a synchronization reference to the other D2D communication enabled devices; and
a processor operatively connected to the transmitter and configured instruct the transmitter to transmit the synchronization signal.

41. The first D2D communication enabled device according to claim 40, wherein the transmitter is configured to convey the information about the intention of the first D2D communication enabled device regarding operation as a synchronization reference in form of a synchronization sequence selected from a set of synchronization sequences reserved for the intention regarding operation as a synchronization reference.

42. The first D2D communication enabled device according to claim 40, wherein the transmitter is configured to convey the information about the intention of the first D2D communication enabled device regarding operation as a synchronization reference by transmitting the synchronization signal on a time/frequency resource selected from a set of time/frequency resources reserved for the intention regarding operation as a synchronization reference.

43. The first D2D communication enabled device according to claim 40, wherein the transmitter is configured to convey the information about the intention of the first D2D communication enabled device regarding operation as a synchronization reference by a parameter transmitted in the synchronization signal, which parameter indicates the intention regarding operation as a synchronization reference.

44. The first D2D communication enabled device according to claim 40, wherein the intention of the first D2D communication enabled device is to operate as a synchronization reference to other D2D communication enabled devices during a time that is substantially longer than a duration of a communication session involving the first D2D communication enabled device.

45. The first D2D communication enabled device according to claim 44, wherein the first D2D communication enabled device is configured to provide connection to a cellular network for those of the other D2D communication enabled devices that are out of coverage of the cellular network.

46. The first D2D communication enabled device according to claim 44, wherein the first D2D communication enabled device is configured to provide synchronization to enable the other D2D communication enabled devices to communicate with each other regardless of whether they are within or out of coverage of the cellular network.

47. The first D2D communication enabled device according to claim 40, wherein the intention of the first D2D communication enabled device is to operate as a synchronization reference to other D2D communication enabled devices during a time that is substantially equal to a duration of a communication session involving the first D2D communication enabled device.

48. The first D2D communication enabled device according to claim 47, wherein the first D2D communication enabled device is configured to perform connectionless communication during the communication session.

49. The first D2D communication enabled device according to claim 40, wherein the intention of the first D2D communication enabled device regarding operation as a synchronization reference is to operate as a public cluster head that transmits synchronization signals and intends to provide synchronization to other D2D communication enabled devices that are not necessarily targets of communication transmitted by the first D2D communication enabled device.

50. The first D2D communication enabled device according to claim 40, wherein the intention of the first D2D communication enabled device regarding operation as a synchronization reference is to operate as a private cluster head that transmits synchronization signals and intends to provide synchronization only to those of the other D2D communication enabled devices that are targets of communication transmitted by the first D2D communication enabled device.

51. The first D2D communication enabled device according to claim 40, wherein the processor is configured to select the synchronization signal in accordance with the intention of the first D2D communication enabled device regarding operation as a synchronization reference to the other D2D communication enabled devices.

52. The first D2D communication enabled device according to claim 40, wherein the synchronization signal is selected in accordance with the intention of the first D2D communication enabled device regarding operation as a synchronization reference by a cellular network node and wherein the first D2D communication enabled device is instructed to transmit the selected synchronization signal by the cellular network node.
